(19) United States
(12) Patent Application Publication
(10) Pub. No.: US 2025/0065417 A1
(43) Pub. Date: Feb. 27, 2025

(54) ROTARY CUTTING TOOL

(71) Applicant: KENNAMETAL INC., Latrobe, PA (US)

(72) Inventor: Bernhard Eckl, Fuerth (DE)

(21) Appl. No.: 18/810,054

(22) Filed: Aug. 20, 2024

(30) Foreign Application Priority Data
Aug. 23, 2023 (DE) 1020231226355

(51) Int. Cl. B23B 27/16

(52) U.S. Cl. CPC B23B 27/16

(57) ABSTRACT

A rotary cutting tool has a tool shank and at least one guide pad, which is fastened on the outer circumference of the tool shank and has a radially external fluid groove. The guide pad has an inlet channel, via which the fluid groove is fluidly connected to an internal fluid line in the tool shank.

### RELATED APPLICATION DATA

The present application claims priority under 35 U.S.C. § 119 to German Patent Application No. 1020231226355, filed on Aug. 23, 2023, the disclosure of which is incorporated by reference herein in its entirety.

### FIELD

The invention relates to a rotary cutting tool having a tool shank and at least one guide pad, which is fastened on the outer circumference of the tool shank and has a radially external fluid groove.

### BACKGROUND

Such rotary cutting tools having guide pads are known.

The guide pads are used in order to support and guide the rotary cutting tool on the workpiece during the cutting operation in order to ensure a defined cut. To keep friction to a minimum, the guide pads are supplied with a lubricant that is provided via holes and grooves in the tool shank as well as via separate caps on the tool shank.

This design of the rotary cutting tool is very complex to manufacture and further has the disadvantage that the diameter size of the rotary cutting tool is severely restricted.

The problem addressed by the invention is to provide a rotary cutting tool that can be manufactured with little effort and provides an effective lubricant supply.

### SUMMARY

The problem is solved by a rotary cutting tool having a tool shank and at least one guide pad, which is fastened on the outer circumference of the tool shank and has a radially external fluid groove. The guide pad has an inlet channel via which the fluid groove is fluidly connected to an internal fluid line in the tool shank.

It has inventively been found that, in this way, the rotary cutting tool can be designed with low complexity and can be manufactured at low cost. Because the fluid supply ends in the fluid groove, the fluid is provided directly at the location where it is required, namely at the guide pad. This makes the fluid supply particularly effective and efficient. Furthermore, this design has the advantage that the rotary cutting tool can be compact and can have a particularly small diameter. Fluid is made available through the groove in a wide section on the outside of the pad. Because the guide pad has an inlet channel, a defined coupling to the internal fluid line is ensured so that fluid flows reliably from the internal fluid line to the fluid groove during operation.

According to one embodiment, the inlet channel is arranged radially on the inside of the guide pad, as a result of which the connection to the internal fluid line is particularly short.

In particular, the inlet channel is directly fluidly connected to the internal fluid line.

The guide pad can have an internal fluid channel extending in the longitudinal direction of the guide pad, via which the inlet channel is fluidly connected to the fluid groove. Because the fluid supply runs through the internal fluid channel and thus through the guide pad, the fluid can be provided particularly efficiently and effectively in the fluid groove.

The fluid groove extends parallel to the guide pad.

Furthermore, it can be provided that the guide pad has at least one through-hole via which the fluid channel is fluidly connected to the fluid groove. The position and geometry of the through-hole define the manner in which the fluid flows from the fluid channel into the fluid groove. In particular, the amount of fluid that flows through the through-hole into the fluid groove during operation can be determined in this way.

In one embodiment, the at least one through-hole has a circular cross-section and thus opens into the fluid groove in a locally limited region.

In an alternative embodiment, the at least one through-hole has a polygonal cross-section.

In a further embodiment, the at least one through-hole has an elongated cross-section and extends over at least 50% of the longitudinal extent of the fluid groove, in particular over at least 90%. In other words, the through-hole here is designed as a slot. This design has the advantage that the through-hole opens into the fluid groove over a significant portion of the longitudinal extent of the fluid groove, so that during operation the fluid flows into the fluid groove over a particularly large region.

In addition, or alternatively, the inlet channel may not overlap with the at least one through-hole when viewed in the radial direction, or the inlet channel may not be arranged directly radially opposite the at least one through-hole. Because the inlet channel is axially offset or spaced apart from the through-hole, the fluid cannot flow in a radial direction out of the inlet channel into the through-hole during operation, but rather is diverted in the fluid channel. This ensures an even distribution of the fluid in the fluid channel, especially at low pressures.

The fluid channel can have a first end section and a second end section positioned opposite thereto in the longitudinal direction. The inlet channel opens into the fluid channel in the first end section, and the at least one through-hole opens into the fluid channel in the second end section. This ensures that fluid flows evenly through essentially the entire fluid channel during operation, in particular at low pressures.

According to one embodiment, the fluid groove extends over at least 50% of the longitudinal extent of the guide pad, in particular at least 75%, whereby sufficient fluid is provided on the guide pad during operation in order to reliably wet it completely with fluid on its guide surface, in particular over the entire longitudinal extent of the guide pad.

According to a further embodiment, the tool shank does not have fluid grooves on the outer circumference, as a result of which the tool shank can be designed with less complexity.

Furthermore, it can be provided that the internal fluid line has a central main channel and a transverse channel, wherein the main channel is fluidly connected to the fluid groove via the transverse channel. In this way, the tool shank can be produced with particularly little effort.

Additionally, or alternatively, the at least one guide pad can be fastened in a receiving slot on the outer circumference of the tool shank. This ensures a defined and reliable fastening of the guide pad.

In one embodiment, at least two guide pads are provided, being distributed around the outer circumference, in order to support and guide the rotary cutting tool particularly effectively during the cutting operation.

The guide pads can be evenly distributed around the outer circumference.

Furthermore, at least one cutting insert can be fastened in the region of an axial end of the tool shank in order to machine a workpiece in the cutting operation.

In a further embodiment, the at least one guide pad projects radially in relation to the outer circumference in order to provide a defined guide and to keep friction between the rotary cutting tool and the workpiece low during the cutting operation.

### BRIEF DESCRIPTION OF THE DRAWINGS

Further advantages and features will emerge from the following description and from the accompanying drawings. These show:

FIG. 1 a perspective view, a rotary cutting tool according to the invention, having first guide pads and second guide pads;

FIG. 2 an aerial view, the rotary cutting tool from FIG. 1;

FIG. 3 the rotary cutting tool in a sectional view along the plane A-A in FIG. 2;

FIG. 4 a side view, a first guide pad from FIG. 1 according to a first embodiment;

FIG. 5 the first guide pad in a sectional view along the plane B-B in FIG. 4;

FIG. 6 the first guide pad in a sectional view along the plane C-C in FIG. 4;

FIG. 7 a side view, a first guide pad from FIG. 1 according to a second embodiment;

FIG. 8 the first guide pad in a sectional view along the plane D-D in FIG. 7;

FIG. 9 the first guide pad in a sectional view along the plane E-E in FIG. 7;

FIG. 10 a side view, a second guide pad from FIG. 1 according to a first embodiment;

FIG. 11 the second guide pad in a sectional view along the plane F-F in FIG. 10;

FIG. 12 the second guide pad in a sectional view along the plane G-G in FIG. 10;

FIG. 13 a side view, a second guide pad from FIG. 1 according to a second embodiment;

FIG. 14 the second guide pad in a sectional view along the plane H-H in FIG. 13; and

FIG. 15 the second guide pad in a sectional view along the plane J-J in FIG. 13.

### DETAILED DESCRIPTION

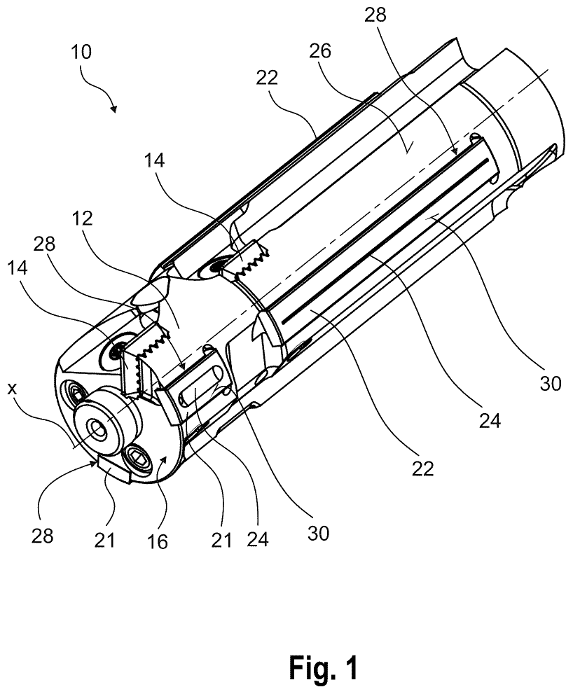

FIG. 1 shows a rotary cutting tool 10 having a tool shank 12 and an axis of rotation X.

The rotary cutting tool 10 here is a reamer.

In principle, the rotary cutting tool 10 can be any rotary cutting tool, for example a drill or a countersink drill.

The rotary cutting tool 10 further has two axially spaced cutting inserts 14, one of which is fastened on an axial end 16 of the tool shank 12.

In an alternative embodiment, the rotary cutting tool 10 can have any number of cutting inserts 14, each of which is fastened at any position on the tool shank 12.

In the exemplary embodiment shown, the cutting inserts 14 are indexable inserts.

The rotary cutting tool 10 further has two first guide pads 21 and three second guide pads 22, each of which has a fluid groove 24.

The guide pads 21, 22 consist of carbide.

In an alternative embodiment, the guide pads 21, 22 consist of ceramic or a diamond-like material such as polycrystalline diamond (PCD).

According to one embodiment, the guide pads 21, 22 are manufactured using an additive manufacturing process, for example by means of 3D printing, as a result of which even complex geometries can be produced with little effort.

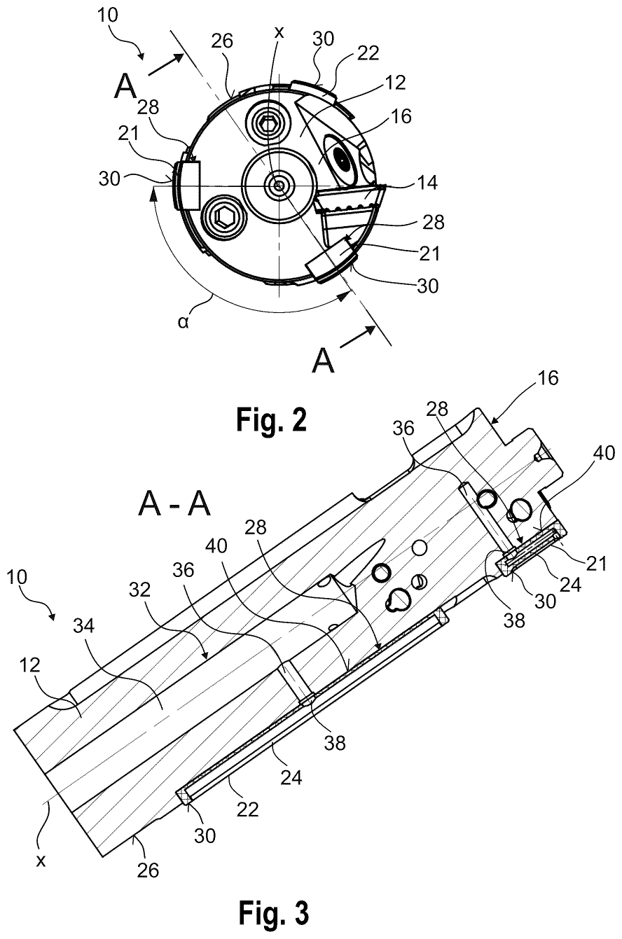

The first guide pads 21 and the second guide pads 22 are each arranged at an angle α of 120° (see FIG. 2) from one another on the outer circumference 26 of the tool shank 12.

The three second guide pads 22 are thus evenly distributed around the outer circumference 26.

Furthermore, the first guide pads 21 are arranged so as to be axially spaced from the second guide pads 22.

In the present exemplary embodiment, the first guide pads 21 are arranged at the axial end 16.

In principle, the rotary cutting tool 10 can have any number of guide pads 21, 22, each of which being fastened at any position on the tool shaft 12, but at least one first guide pad 21 or one second guide pad 22.

In particular, in one embodiment, the rotary cutting tool 10 may have no first guide pads 21 or no second guide pads 22.

The guide pads 21, 22 are each fastened in a correspondingly designed receiving slot 28 on the outer circumference 26.

For example, the guide pads 21, 22 are connected to the tool shank 12 with a material bond, in particular glued or soldered.

Additionally, or alternatively, the guide pads 21, 22 can be connected to the tool shank 12 in a form-fit and/or force-fit manner, for example via a screw connection.

Furthermore, the guide pads 21, 22 are fastened on the tool shank 12 in such a way that a radially external guide surface 30 of each of the guide pads 21, 22 projects radially in relation to the outer circumference 26.

In this context, the fluid grooves 24 are respectively arranged in or open into the guide surface 30 of the corresponding guide pad 21, 22.

In order to supply the fluid grooves 24 with fluid during operation, the tool shank 12 has an internal fluid line 32 (see FIG. 3), which is fluidly connected to the fluid grooves 24.

The fluid is, for example, a lubricant, in particular a cooling lubricant.

In the present exemplary embodiment, the internal fluid line 32 has a central main channel 34 as well as five transverse channels 36, which are fluidly connected to the main channel 34 and extend radially to the outer circumference 26 and which are respectively associated with one of the guide pads 21, 22.

The transverse channels 36 each end radially opposite an inlet channel 38, which is arranged in an underside 40 of the corresponding guide pad 21, 22.

The underside 40 is arranged opposite the guide surface 30 and thus radially inwards.

During operation, the fluid flows from the central main channel 34, which is connected to a fluid source, via the transverse channels 36, through the inlet channels 38, into the guide pads 21, 22, and from there via the fluid grooves 24 out of the guide pads 21, 22 and to the guide surfaces 30.

In this context, the tool shank 12 itself has no external fluid groove, in particular not on the outer circumference 26.

This means that during operation, the fluid for lubricating the guide pads 21, 22 is essentially provided via the fluid grooves 24 in the guide pads 21, 22.

In this context, the internal fluid line 32 is directly fluidly connected to the inlet channels 38, so that during operation, the fluid flows directly out of the internal fluid line 32 into the inlet channels 38.

In an alternative embodiment, the tool shank 12 can additionally have external fluid grooves on the outer circumference 26 in order to lubricate the guide pads 21, 22.

In all embodiments, the tool shank 12 can have fluid outlets or nozzles by means of which fluid is provided during operation to components or sections of the rotary cutting tool 10 that are not guide pads 21, 22, in particular to the cutting inserts 14.

The proportion of the fluid that reaches the guide pads 21, 22, in particular the guide surfaces 30, via these fluid outlets or nozzles is negligible compared to the proportion of the fluid that is provided directly to the guide surfaces 30 via the fluid groove 24.

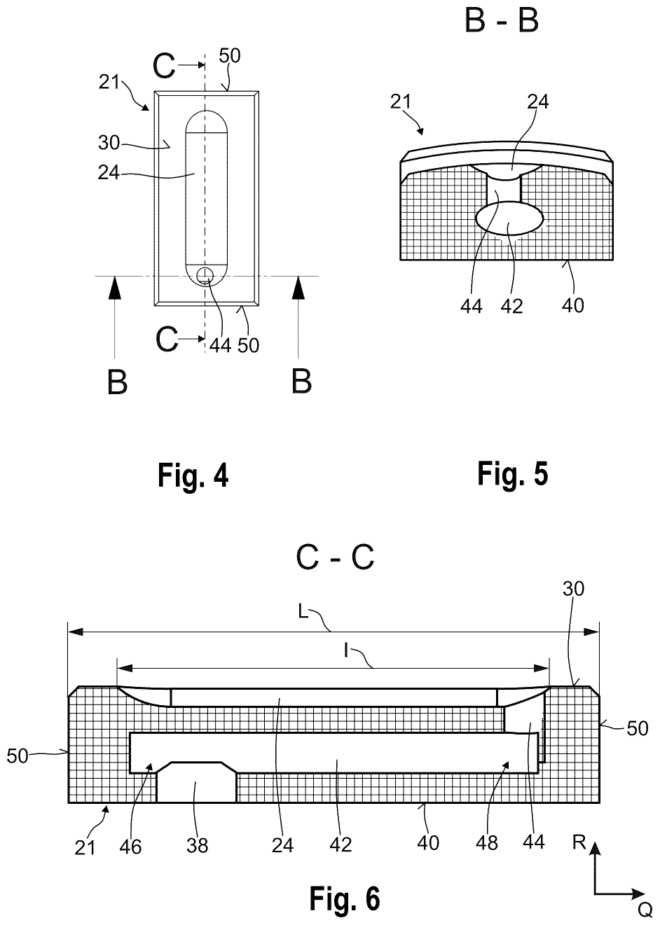

With reference to FIGS. 4 to 6, the structure of a first guide pad 21 according to a first embodiment will now be described.

The fluid groove 24 of the first guide pad 21 has a longitudinal extent I in a longitudinal direction Q, which is approximately 80% of the longitudinal extent L of the first guide pad 21.

The longitudinal direction Q extends in an axial direction, i.e. parallel to the axis of rotation X.

In an alternative embodiment, the fluid groove 24 can extend over any proportion of the longitudinal extent L, but preferably over at least 50%, in particular over at least 75%.

The first guide pad 21 has an internal fluid channel 42 and a through-hole 44, via which the inlet channel 38 is fluidly connected to the fluid groove 24.

The fluid channel 42 extends in the longitudinal direction Q and has a first end section 46 and a second end section 48, which is arranged opposite the first end section 46 in the longitudinal direction Q.

In the present embodiment, the fluid channel 42 has an oval cross-section (see FIG. 5).

In an alternative embodiment, the fluid channel 42 can have any cross-section, for example circular, polygonal, or rectangular.

The inlet channel 38 extends in the radial direction R and opens into the fluid channel 42 in the first end section 46.

The cross-section of the inlet channel 38 is circular here.

In principle, the inlet channel 38 can have any cross-section. Preferably, however, the cross-section is designed so as to be complementary to the cross-section of the associated transverse channel 36.

The through-hole 44 extends in the radial direction R and opens into the fluid channel 42 in the second end section 48.

The cross-section of the through-hole 44 is circular here.

In principle, the through-hole 44 can have any cross-section.

In the present embodiment, the inlet channel 38 and the through-hole 44 are arranged spaced apart from one another in the longitudinal direction Q, so that they do not overlap with one another when viewed in the radial direction R.

In an alternative embodiment, the inlet channel 38 and the through-hole 44 can each be arranged at any position in the longitudinal direction Q or can open into the fluid channel 42.

During operation, the fluid flows from the inlet channel 38 via the fluid channel 42, through the through-hole 44 into the fluid groove 24, and is thus made available at the guide surface 30.

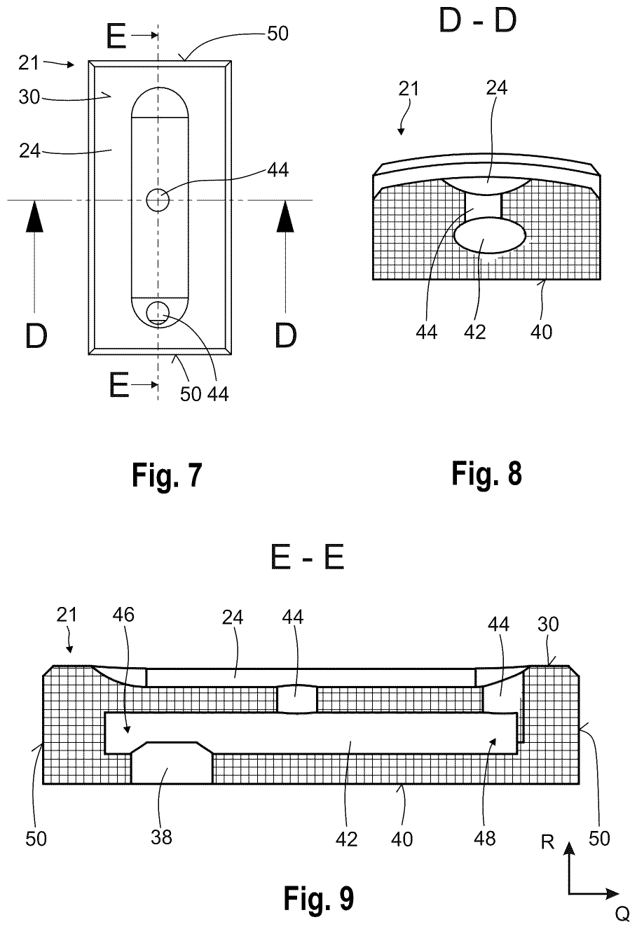

With reference to FIGS. 7 to 9, a first guide pad 21 according to a second embodiment is now described. The same reference signs are used for the components and features known from the above embodiment, and reference is made in this respect to the preceding explanations.

By contrast to the first embodiment of the first guide pad 21, the second embodiment of the first guide pad 21 has a further through-hole 44, which opens centrally into the fluid channel 42 in the longitudinal direction Q.

Of course, the further through-hole 44 can open into the fluid channel 42 at any point, for example in the first end section 46.

In principle, in an alternative embodiment, the first guide pad 21 can have any number of through-holes 44.

In an embodiment with a plurality of through-holes 44, these can be identical or individually designed.

During operation, the fluid flows from the inlet channel 38 via the fluid channel 42, through the through-holes 44 into the fluid groove 24, and is thus made available at the guide surface 30.

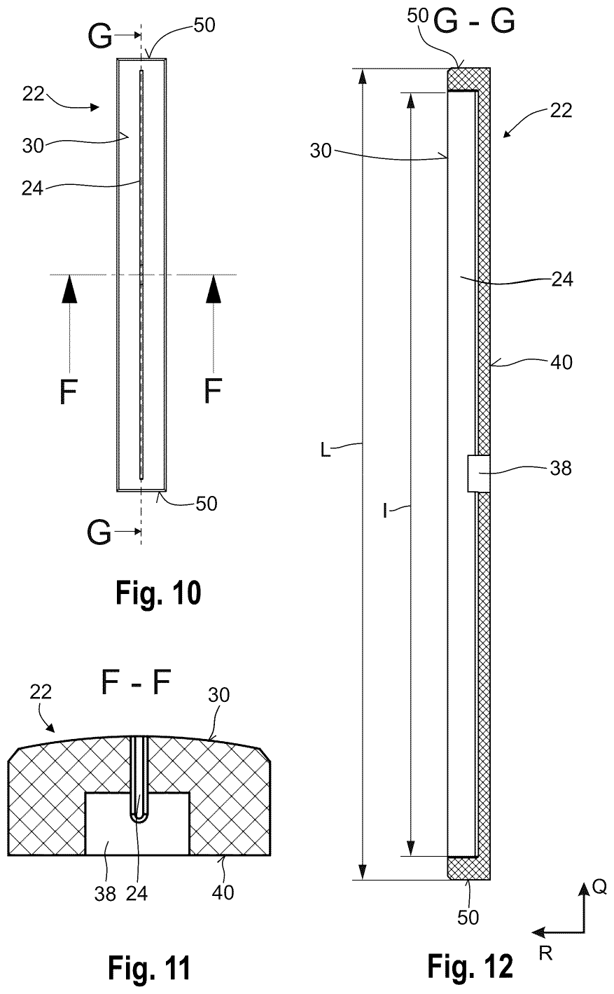

With reference to FIGS. 10 to 12, a second guide pad 22 according to a first embodiment is now described. The same reference signs are used for the components and features known from the above embodiment, and reference is made in this respect to the preceding explanations.

The fluid groove 24 of the second guide pad 22 has a longitudinal extent I in the longitudinal direction Q, which is approximately 95% of the longitudinal extent L of the second guide pad 22

By contrast to the first guide pad 21, the second guide pad 22 has no internal fluid channel 42 and no through-hole 44.

In the embodiment shown, the inlet channel 38 opens into the fluid groove 24.

During operation, the fluid flows from the inlet channel 38 directly into the fluid groove 24 and is thus made available at the guide surface 30.

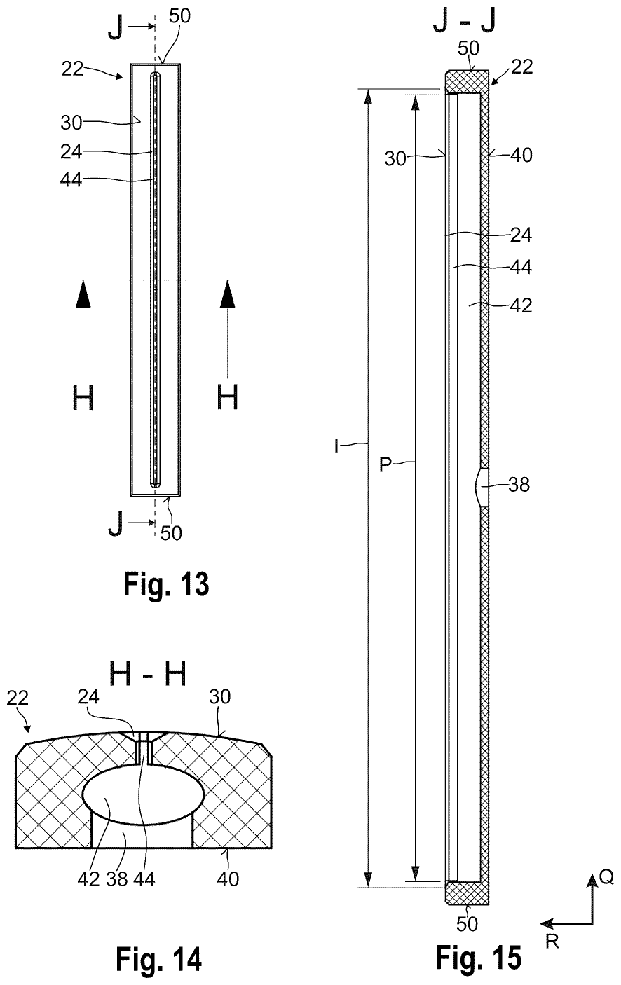

With reference to FIGS. 13 to 15, a second guide pad 22 according to a second embodiment is now described. The same reference signs are used for the components and features known from the above embodiment, and reference is made in this respect to the preceding explanations.

By contrast to the first embodiment of the second guide pad 22, the second embodiment of the second guide pad 22 has an internal fluid channel 42 and a through-hole 44, via which the inlet channel 38 is fluidly connected to the fluid groove 24.

The through-hole 44 has an elongated cross-section and is therefore slot-shaped.

In the present embodiment, the through-hole 44 has a length P in the longitudinal direction Q, which corresponds to approximately 95% of the longitudinal extent I of the fluid groove 24.

In an alternative embodiment, the length P can be any proportion of the longitudinal extent I of the fluid groove 24, for example at least 50%, in particular at least 90%.

During operation, the fluid flows from the inlet channel 38 via the fluid channel 42, through the through-hole 44 into the fluid groove 24, and is thus made available at the guide surface 30.

In a further alternative embodiment, the through-hole 44 can be omitted, so that the fluid groove 24 opens directly into the fluid channel 42.

In this case, during operation, the fluid flows from the inlet channel 38 via the fluid channel 42 directly into the fluid groove 24 and is thus made available at the guide surface 30.

In principle, in an alternative embodiment, the fluid groove 24, the inlet channel 38, the fluid channel 42, and/or the through-hole 44 can abut or open into an axial end face 50 of the second guide pad 22 in the longitudinal direction Q. This allows the fluid to be guided to a different position via a plurality of guide pads 21, 22 arranged one behind the other in the longitudinal direction Q and/or over a longer distance.

In addition, or alternatively, the guide pads 21, 22 can be designed to have a plurality of parts, in particular having sections that abut one another in the longitudinal direction Q.

Furthermore, in a further embodiment, the inlet channel 38 can open into the axial end face 50 and be fluidly connected thereby to a correspondingly designed internal fluid line 32.

In all embodiments, a rotary cutting tool 10 is provided in this way, which can be manufactured with little effort due to its particularly simple design.

The invention is not limited to the embodiments shown. Individual features of one embodiment can in particular be combined as desired with features of other embodiments, in particular independently of the other features of the corresponding embodiments.

In particular, the first guide pads 21 can have features of the second guide pads 22, and vice versa.

1. A rotary cutting tool having a tool shank and at least one guide, which is fastened on the outer circumference of the tool shank and has a radially external fluid groove, wherein the guide pad has an inlet channel, via which the radially external fluid groove is fluidly connected to an internal fluid line in the tool shank.

2. The rotary cutting tool according to claim 1, wherein the inlet channel is arranged radially on the inside of the guide pad.

3. The rotary cutting tool according to claim 1, wherein the guide pad has an internal fluid channel which extends in the longitudinal direction of the guide pad and via which the inlet channel is fluidly connected to the fluid groove.

4. The rotary cutting tool according to claim 2, wherein the guide pad has an internal fluid channel which extends in the longitudinal direction of the guide pad and via which the inlet channel is fluidly connected to the fluid groove.

5. The rotary cutting tool according to claim 3, wherein the guide pad has at least one through-hole, via which the fluid channel is fluidly connected to the fluid groove.

6. The rotary cutting tool according to claim 4, wherein the guide pad has at least one through-hole, via which the fluid channel is fluidly connected to the fluid groove.

7. The rotary cutting tool according to claim 5, wherein the at least one through-hole has a circular or polygonal cross-section.

8. The rotary cutting tool according to claim 5, wherein the at least one through-hole has an elongated cross-section and extends over at least 50% of the longitudinal extent of the fluid groove.

9. The rotary cutting tool according to claim 5, wherein the at least one through-hole has an elongated cross-section and extends over at least 90% of the longitudinal extent of the fluid groove.

10. The rotary cutting tool according to claim 5, wherein the inlet channel does not overlap with the at least one through-hole when viewed in the radial direction.

11. The rotary cutting tool according to claim 7, wherein the inlet channel does not overlap with the at least one through-hole when viewed in the radial direction.

12. The rotary cutting tool according to claim 10, wherein the fluid channel has a first end section and a second end section positioned opposite thereto in the longitudinal direction, wherein the inlet channel opens into the fluid channel in the first end section and the at least one through-hole opens into the fluid channel in the second end section.

13. The rotary cutting tool according to claim 1, wherein the fluid groove extends over at least 50% of the longitudinal extent of the guide pad.

14. The rotary cutting tool according to claim 1, wherein the fluid groove extends over at least 75% of the longitudinal extent of the guide pad.

15. The rotary cutting tool according to claim 1, wherein the tool shank has no fluid groove on the outer circumference.

16. The rotary cutting tool according to claim 1, wherein the internal fluid line has a central main channel and a transverse channel, wherein the main channel is fluidly connected to the fluid groove via the transverse channel.

17. The rotary cutting tool according to claim 1, wherein the at least one guide pad is fastened in a receiving slot on the outer circumference of the tool shank.

18. The rotary cutting tool according to claim 1, wherein at least two guide pads are provided, being distributed on the outer circumference.

19. The rotary cutting tool according to claim 1, wherein at least one cutting insert is fastened in the region of an axial end of the tool shank.

20. The rotary cutting tool according to claim 1, wherein at least one guide pad projects radially in relation to the outer circumference.
